(19) United States
(12) Patent Application Publication
(10) Pub. No.: US 2025/0357600 A1
(43) Pub. Date: Nov. 20, 2025

(54) POWER STORAGE DEVICE

(71) Applicant: TOYOTA JIDOSHA KABUSHIKI KAISHA, Toyota-shi (JP)

(72) Inventors: Shigeyuki INOUE, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 19/175,224

(22) Filed: Apr. 10, 2025

(30) Foreign Application Priority Data
May 16, 2024 (JP) 2024-080187

(51) Int. Cl. H01M 50/242; H01M 10/625; H01M 10/658; H01M 50/209; H01M 50/249; H01M 50/289; H01M 50/367

(52) U.S. Cl. CPC H01M 50/242; H01M 10/625; H01M 10/658; H01M 50/209; H01M 50/249; H01M 50/289; H01M 50/367

(57) ABSTRACT

In a power storage device, a smoke exhaust hole positioned to overlap a safety valve of a power storage cell is formed in a bottom plate of a lower case. A support unit includes a panel connection portion connected to a share panel. The panel connection portion is disposed below the power storage cell.

### CROSS REFERENCE TO RELATED APPLICATIONS

This nonprovisional application is based on Japanese Patent Application No. 2024-080187 filed on May 16, 2024 with the Japan Patent Office, the entire contents of which are hereby incorporated by reference.

### BACKGROUND

### Field

The present disclosure relates to a power storage device.

### Description of the Background Art

Japanese National Patent Publication No. 2022-525014 discloses a power battery pack mounted in a battery electric vehicle. The power battery pack includes a plurality of cells. Each of the plurality of cells is provided with an explosion-proof valve for discharging the smoke or gas inside the cell.

### SUMMARY

Although not described in Japanese National Patent Publication No. 2022-525014 above, the smoke or gas may be discharged from the lower surface of the cell (power storage cell) by the explosion-proof valve (safety valve) provided on the lower surface of the cell. In this configuration, a smoke exhaust space (smoke exhaust path) is formed below the cell. In this case, the member that forms the smoke exhaust space may be damaged when, for example, the power storage device interferes with a road surface and is subject to a load from below.

The present disclosure has been made to solve the problem described above. An object of the present disclosure is to provide a power storage device that can have increased rigidity of a member that forms a smoke exhaust space formed below a power storage device.

A power storage device according to an aspect of the present disclosure includes at least one power storage cell and a housing. The at least one power storage cell includes a lower surface on which a safety valve is provided. The housing includes a lower case supporting the at least one power storage cell from below, a share panel provided below the lower case and forming a space between a bottom surface of the lower case and the share panel, and a lower case support plate disposed between the lower case and the share panel and supporting the lower case. The bottom surface of the lower case has a through hole, the through hole being positioned to overlap the safety valve of the at least one power storage cell. The lower case support plate includes a panel connection portion connected to the share panel. The panel connection portion is disposed below the at least one power storage cell.

In the power storage device according to the aspect of the present disclosure, the panel connection portion is disposed below the at least one power storage cell, as described above. Consequently, the share panel is pressed from above by the lower case support portion via the panel connection portion, and thus, movement (e.g., deformation to be recessed upward or vibration in the upward-downward direction) of the share panel in response to a load applied from below can be suppressed. Thus, the rigidity of the share panel against the load applied from below can be increased. This can increase the rigidity of the share panel that forms a space (smoke exhaust space) formed below the power storage cell.

The power storage device may include a surrounding member disposed in the space between the share panel and the bottom surface of the lower case and surrounding a region of the bottom surface of the lower case, the through hole being formed in the region. The lower case support plate may include a blast collection portion located outside the surrounding member. With such a configuration, a blast scattered to the outside of the through hole surrounding member can be collected by the blast collection portion.

The blast collection portion may include a first part extending upward from the panel connection portion, and a second part projecting from an upper portion of the first part toward the surrounding member. With such a configuration, since the first part extends upward from the panel connection portion, scattering of a blast beyond the first part can be suppressed. Further, since the second part projects from the upper portion of the first part toward the surrounding member, scattering of a blast can be suppressed from above by the second part. Consequently, scattering of a blast beyond the first part can be suppressed further.

The power storage device may further include a support member disposed in a gap formed between the share panel and a portion of the lower case support plate, the portion being different from the panel connection portion, the support member supporting the lower case support plate from below. With such a configuration, the lower case can be supported more stably than when no support member is provided.

The support member may be provided opposite to the through hole relative to the panel connection portion. With such a configuration, since no gap is formed between the lower case support plate and the share panel at the position at which the panel connection portion is provided, scattering of a blast from the through hole to the support member can be suppressed.

The panel connection portion may include a first connection portion and a second connection portion. With such a configuration, the rigidity of the share panel can be increased more than when only one panel connection portion is provided.

The at least one power storage cell may be formed to be elongated in a connection portion arrangement direction in which the first connection portion and the second connection portion are arranged. With such a configuration, the portion of the share panel which extends in the long direction of the power storage cell can be pressed by the first connection portion and the second connection portion. As a result, a relatively long portion of the share panel which extends in the long direction of the power storage cell can be pressed by both the first connection portion and the second connection portion. This can effectively increase the rigidity of the share panel.

The at least one power storage cell may include a plurality of power storage cells arranged in a cell arrangement direction such that a plurality of the safety valves are arranged in the cell arrangement direction. The panel connection portion includes a cell-arrangement-direction extending portion extending in the cell arrangement direction along the plurality of power storage cells. With such a configuration, since the panel connection portion (cell-arrangement-direction extending portion) that increases the rigidity of the share panel extends along the cell arrangement direction, and accordingly, the rigidity of the share panel can be increased further.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 schematically shows a vehicle including a power storage device according to an embodiment.

FIG. 2 is a perspective view of the power storage device and a vehicle body according to the embodiment.

FIG. 3 is a sectional view taken along the line III-III in FIG. 2.

FIG. 4 is a perspective view showing a configuration of a power storage cell.

FIG. 5 is a perspective view showing a configuration of a lower case of the power storage device.

FIG. 6 is a perspective view showing a configuration of the lower case with a bracket unit attached thereto.

FIG. 7 is an exploded perspective view showing configurations of the lower case and a cooler.

FIG. 8 is an exploded perspective view showing configurations of the lower case and an inner path defining portion.

FIG. 9 is an exploded perspective view showing configurations of the lower case, a support unit, and a share panel.

FIG. 10 is a plan view of the lower case seen from below.

FIG. 11 is a sectional view taken along the line XI-XI in FIG. 10.

FIG. 12 is a plan view showing a configuration of a spacer.

FIG. 13 is a partially enlarged view of a panel connection portion and its vicinity in FIG. 11.

FIG. 14 is a partially enlarged view of a protrusion and its vicinity in FIG. 11.

FIG. 15 is a partially enlarged view of a cross member and its vicinity in FIG. 11.

### DESCRIPTION OF THE PREFERRED EMBODIMENTS

An embodiment of the present disclosure will be described with reference to the drawings. In the drawings referred to below, the same or corresponding components have the same reference characters allotted.

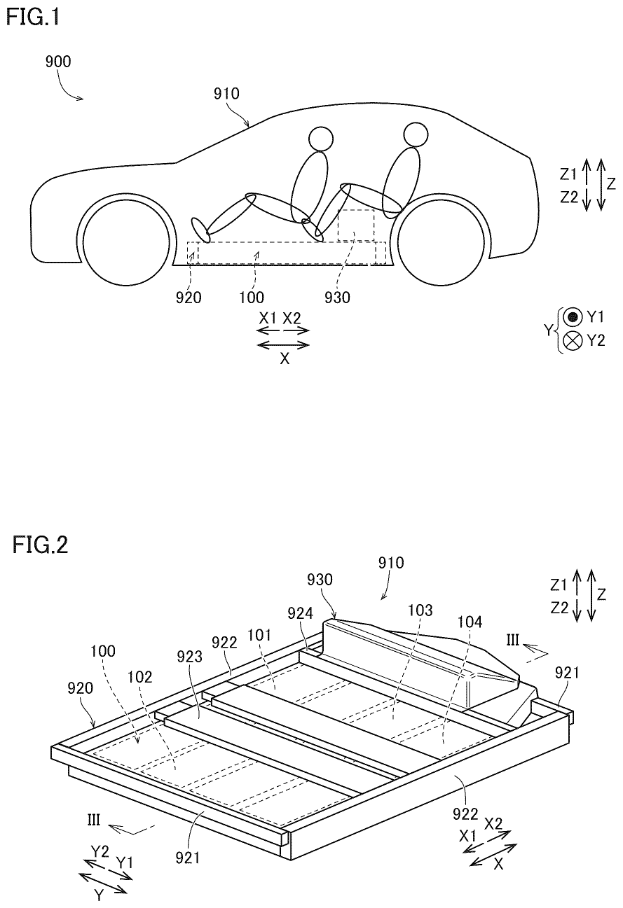

A power storage device 100 in an embodiment of the present disclosure will be described with reference to FIGS. 1 to 15. FIG. 1 is a schematic side view of a vehicle 900 including power storage device 100 according to the present embodiment. In this specification, an X direction, a Y direction, and a Z direction are orthogonal to one another. For example, the X direction and the Y direction are the front-rear direction and the vehicle width direction of vehicle 900, respectively, when power storage device 100 is mounted in vehicle 900. An X1 direction and an X2 direction are the vehicle front side and the vehicle rear side, respectively. A Y1 direction and a Y2 direction are the vehicle left side and the vehicle right side, respectively. The Z direction is the upward-downward (vertical) direction. The X direction and the Y direction are examples of the “cell arrangement direction” and the “connection portion arrangement direction”, respectively, in the present disclosure.

As shown in FIG. 1, vehicle 900 includes a vehicle body 910 and a device unit 930, in addition to power storage device 100. Examples of vehicle 900 include a hybrid electric vehicle, a plug-in hybrid electric vehicle, and a battery electric vehicle. Vehicle body 910 includes a frame member 920. Frame member 920 is disposed at the bottom of vehicle body 910.

As shown in FIG. 2, frame member 920 includes a pair of first frames 921, a pair of second frames 922, a first cross frame 923, and a second cross frame 924.

The pair of first frames 921 face each other in the X direction. Each first frame 921 is shaped to extend along the Y direction.

The pair of second frames 922 face each other in the Y direction. Each second frame 922 is shaped to extend along the X direction. The ends of each second frame 922 in the X direction are connected to first frames 921. The pair of second frames 922 form an approximately square prism that surrounds power storage device 100 together with the pair of first frames 921.

First cross frame 923 is disposed between the pair of first frames 921 and connects the pair of second frames 922 to each other.

Second cross frame 924 is disposed between the pair of first frames 921 and connects the pair of second frames 922 to each other. Second cross frame 924 is spaced apart from first cross frame 923 in the X direction. Each of first cross frame 923 and second cross frame 924 forms, for example, a seat cross.

Power storage device 100 is attached to frame member 920. Power storage device 100 is disposed below first cross frame 923 and second cross frame 924. Power storage device 100 includes four power storage stacks 101 to 104. The number of power storage stacks is not limited to four.

In the present embodiment, each of power storage stacks 101 to 104 is shaped into a rectangular parallelepiped elongated in the X direction. As shown in FIG. 2, the four power storage stacks 101 to 104 are disposed side by side along the Y direction.

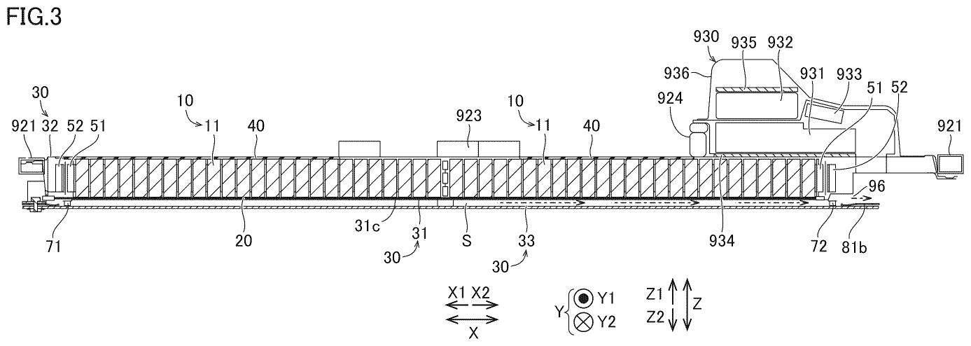

FIG. 3 is a sectional view taken along the line III-III in FIG. 2. As shown in FIG. 3, power storage device 100 includes a power storage cell 10, a cooler 20, a housing 30, and a reinforcing member 40. At least one power storage cell 10 is included in each of power storage stacks 101 to 104 (FIG. 2). In the present embodiment, in each of power storage stacks 101 to 104, a plurality of (e.g., 50) power storage cells 10 are arranged in the X direction. In FIG. 3, the direction of gas that can be discharged from a safety valve SV (which will be described later) is indicated by the alternate long and short dash line arrows.

Each power storage cell 10 includes an electrode body 11. Electrode body 11 may be formed of a wound body of a positive electrode sheet and a negative electrode sheet wound with a separator in between, or may be formed of a stack of a positive electrode sheet and a negative electrode sheet stacked with a separator in between. Electrode body 11 is shaped to be long in the Y direction.

Cooler 20 cools power storage cells 10. In the present embodiment, cooler 20 cools each of power storage stacks 101 to 104 (FIG. 2). A cooling medium (e.g., oil) flows through cooler 20.

Housing 30 includes a lower case 31, an upper cover 32, and a share panel 33. Upper cover 32 accommodates power storage cells 10, together with lower case 31. In the present embodiment, upper cover 32 accommodates four power storage stacks 101 to 104 (FIG. 2) in a hermetically sealed manner, together with lower case 31. Upper cover 32 is disposed to cover each of power storage stacks 101 to 104 from above. Lower case 31 is disposed to support each of power storage stacks 101 to 104 from below. The peripheral edge of upper cover 32 is connected to the peripheral edge of lower case 31 with bolts or the like with a sealing member in between. Share panel 33 is provided below lower case 31. Share panel 33 has the function of protecting lower case 31. Share panel 33 may be shaped into a flat plate.

A bottom plate 31c of lower case 31 and share panel 33 are located below power storage cells 10. In addition, a smoke exhaust space S is formed between bottom plate 31c and share panel 33. Smoke exhaust space S forms a smoke exhaust path through which gas from power storage cell 10 flows. Smoke exhaust space S and bottom plate 31c are examples of the “space” and the “bottom surface”, respectively, in the present disclosure.

On the opposite sides of power storage cells 10 in the X direction, a pair of end plates 51 are provided that sandwich power storage cells 10 from the opposite sides in the X direction. A monitoring unit (smart battery management) 52 is disposed outside each end plate 51 in the X direction.

Device unit 930 is located at, for example, an end in the X direction. In the present embodiment, device unit 930 is disposed in the rear of upper cover 32 in the front-rear direction of vehicle 900. Device unit 930 has a junction box 931, an electricity supply unit 932, an electronic control unit 933, a first cooler 934, a second cooler 935, and a device cover 936.

Junction box 931 is disposed above upper cover 32. Junction box 931 accommodates a relay, a fuse, and the like. Junction box 931 is cooled by first cooler 934 disposed between junction box 931 and upper cover 32.

Electricity supply unit 932 is disposed above junction box 931. Electricity supply unit 932 is cooled by second cooler 935 disposed on electricity supply unit 932. Electronic control unit 933 is disposed above junction box 931.

Device cover 936 accommodates junction box 931, electricity supply unit 932, electronic control unit 933, and second cooler 935.

Reinforcing member 40 is disposed on upper cover 32. Reinforcing member 40 has the function of distributing a load exerted on power storage device 100 locally from above by an occupant of vehicle 900.

When gas is discharged from any power storage cell 10, the gas is discharged out of housing 30 through smoke exhaust space S.

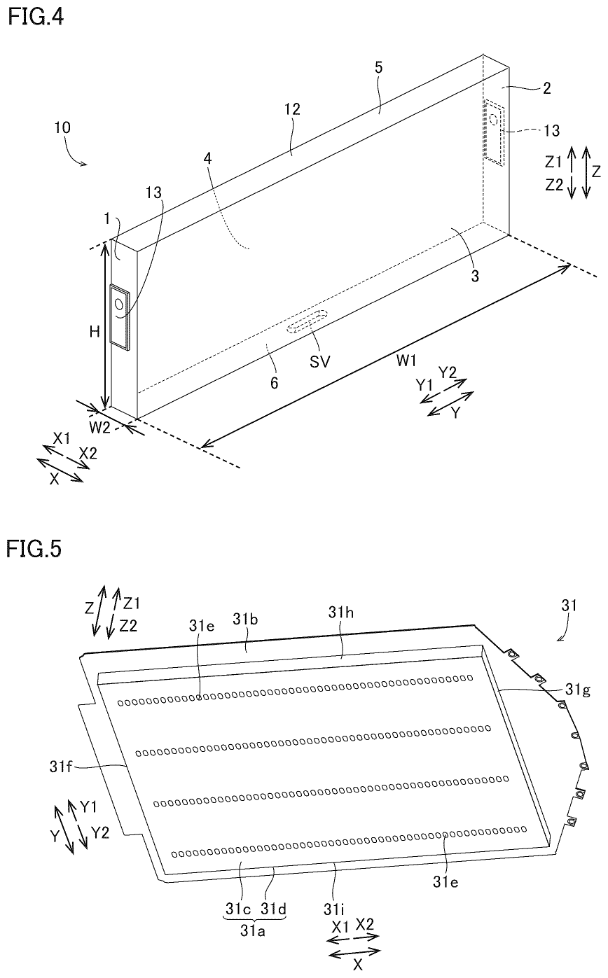

FIG. 4 is a perspective view showing a configuration of power storage cell 10. As shown in FIG. 4, each power storage cell 10 has a cell case 12, a pair of external terminals 13, and safety valve SV. Cell case 12 accommodates electrode body 11 (FIG. 3).

Cell case 12 is shaped into a rectangular parallelepiped. Cell case 12 is made of a metal such as aluminum. Power storage cell 10 is formed to be elongated in the Y direction. Specifically, a width W1 of power storage cell 10 in the Y direction is greater than a width W2 of power storage cell 10 in the X direction. A height H of power storage cell 10 is smaller than width W1 and greater than width W2.

Power storage cell 10 (cell case 12) has a short side surface 1, a short side surface 2, a long side surface 3, a long side surface 4, an upper surface 5, and a lower surface 6.

Short side surface 1 and short side surface 2 are arranged in the Y direction. Specifically, short side surface 1 and short side surface 2 are one end face and the other end face, respectively, of power storage cell 10 in the Y direction.

Long side surface 3 and long side surface 4 are arranged in the X direction. Specifically, long side surface 3 and long side surface 4 are one end face and the other end face, respectively, of power storage cell 10 in the X direction.

Upper surface 5 and lower surface 6 are arranged in the Z direction. Specifically, upper surface 5 and lower surface 6 are a Z1-side end face and a Z2-side end face, respectively, of power storage cell 10.

The pair of external terminals 13 are respectively provided on short side surface 1 and short side surface 2. Safety valve SV is provided on lower surface 6. Safety valve SV opens when the pressure of the smoke or gas inside cell case 12 becomes more than or equal to a certain level. In other words, lower surface 6, on which safety valve SV is provided, forms a pressure release surface of cell case 12.

FIG. 5 is a perspective view showing a configuration of lower case 31. Lower case 31 includes an accommodation portion 31a and a plate portion 31b. Accommodation portion 31a includes bottom plate 31c and a peripheral wall 31d. Bottom plate 31c is shaped into a plate, and bottom plate 31c has a plurality of smoke exhaust holes 31e. Smoke exhaust holes 31e are arranged in the front-rear direction (X direction) of vehicle 900. In addition, a plurality of (in FIG. 5, four) rows of smoke exhaust holes 31e, which are arranged in the X direction, are arranged in the Y direction. Smoke exhaust hole 31e is an example of the “through hole” in the present disclosure.

Peripheral wall 31d is formed to extend upward from the outer peripheral edge of bottom plate 31c. Peripheral wall 31d is formed in an annular shape. Peripheral wall 31d includes a front wall 31f disposed on the front side (X1 side), a rear wall 31g disposed on the rear side (X2 side), a left wall 31h disposed on the left side (Y1 side), and a right wall 31i disposed on the right side (Y2 side). Accommodation portion 31a has an opening that opens upward. Plate portion 31b is formed to protrude horizontally from the opening edge of accommodation portion 31a.

Herein, power storage cells 10 are disposed in accommodation portion 31a. Safety valve SV (FIG. 4) of power storage cell 10 and smoke exhaust hole 31e are arranged in the Z direction, and safety valve SV is in communication with smoke exhaust hole 31e.

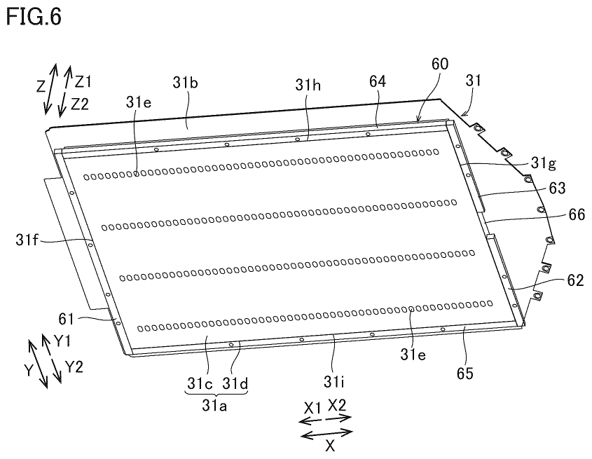

As shown in FIG. 6, power storage device 100 includes a bracket unit 60 provided on the outer peripheral surface of accommodation portion 31a. Bracket unit 60 is provided on the outer surface of peripheral wall 31d of lower case 31. Bracket unit 60 includes a front bracket 61, a rear bracket 62, a rear bracket 63, a side bracket 64, and a side bracket 65.

Front bracket 61 is fixed to the outer surface of front wall 31f of lower case 31. Each of rear bracket 62 and rear bracket 63 is provided on the outer surface of rear wall 31g. Rear bracket 62 is spaced apart from rear bracket 63 in the Y direction. A gap 66 is formed between rear bracket 62 and rear bracket 63. Gap 66 is located at the center of rear wall 31g in the Y direction.

Side bracket 64 is provided on the outer surface of left wall 31h. Side bracket 65 is provided on the outer surface of right wall 31i.

Bracket unit 60 is formed in an approximately annular shape, and has gap 66 formed on the rear side (X2 side) in the X direction.

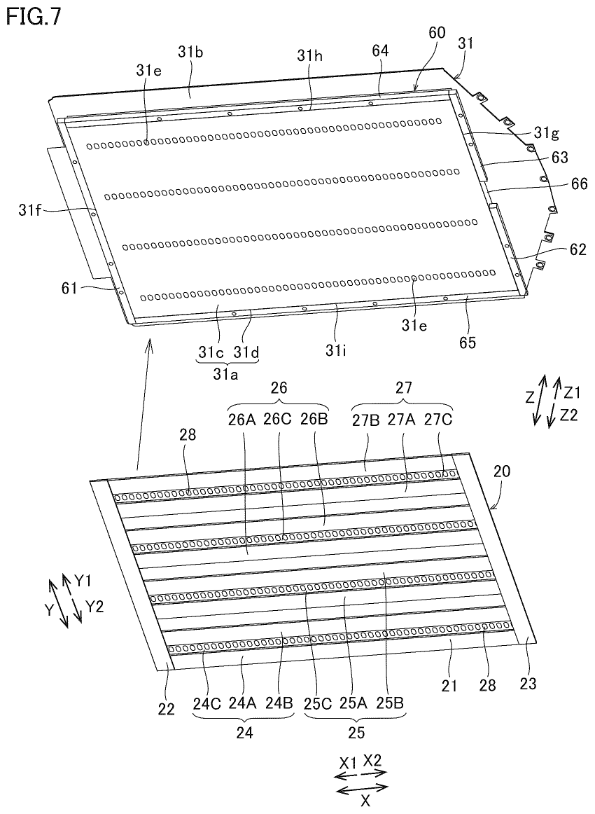

FIG. 7 is a perspective view of lower case 31, bracket unit 60, and cooler 20. Cooler 20 includes a cooling portion 21, a connection portion 22, and a connection portion 23.

Cooling portion 21 is formed to extend in the X direction. Connection portion 22 is provided at the front end (X1-side end) of cooling portion 21, and connection portion 23 is provided at the rear end (X2-side end) of cooling portion 21.

Connection portion 22 is connected with a supply pipe (not shown) and a discharge pipe (not shown). A cooling liquid is supplied from the supply pipe. The cooling liquid flows through cooling portion 21 and connection portion 22 and returns to connection portion 22. The cooling liquid that has returned to connection portion 22 is discharged from the exhaust pipe.

Power storage stacks 101 to 104 (FIG. 2) are disposed above cooling portion 21 with bottom plate 31c of lower case 31 in between. Cooling portion 21 includes a first cooling portion 24, a second cooling portion 25, a third cooling portion 26, and a fourth cooling portion 27. First cooling portion 24, second cooling portion 25, third cooling portion 26, and fourth cooling portion 27 are arranged in the stated order from the Y2 side (in the Y direction).

First cooling portion 24 has a flow portion 24A, a flow portion 24B, and a connecting plate 24C. Second cooling portion 25 has a flow portion 25A, a flow portion 25B, and a connecting plate 25C. Third cooling portion 26 has a flow portion 26A, a flow portion 26B, and a connecting plate 26C. Fourth cooling portion 27 has a flow portion 27A, a flow portion 27B, and a connecting plate 27C. First cooling portion 24, second cooling portion 25, third cooling portion 26, and fourth cooling portion 27 have the same configuration, and thus, only first cooling portion 24 will be described in detail as a representative example.

Flow portion 24A and flow portion 24B are spaced apart from each other in the Y direction. Each of flow portion 24A and flow portion 24B is formed to extend in the X direction.

Connecting plate 24C is disposed between flow portion 24A and flow portion 24B and is provided to connect flow portion 24A to flow portion 24B.

Connecting plate 24C has a plurality of holes 28. Holes 28 are spaced apart from each other in the X direction.

Holes 28 correspond respectively to smoke exhaust holes 31e formed in bottom plate 31c. With cooler 20 being fixed to lower case 31, holes 28 and smoke exhaust holes 31e are arranged in the Z direction.

Instead of holes 28 arranged in the X direction, an opening formed to be elongated in the X direction may be formed. In the opening as described above, with cooler 20 being fixed to lower case 31, smoke exhaust holes 31e formed in lower case 31 are in communication with the opening. Configuring such an opening can facilitate alignment of the opening with smoke exhaust holes 31e.

Cooler 20 is fixed to bottom plate 31c of lower case 31. Specifically, cooler 20 is fixed to bottom plate 31c with a thermally conductive adhesive (not shown in FIG. 7).

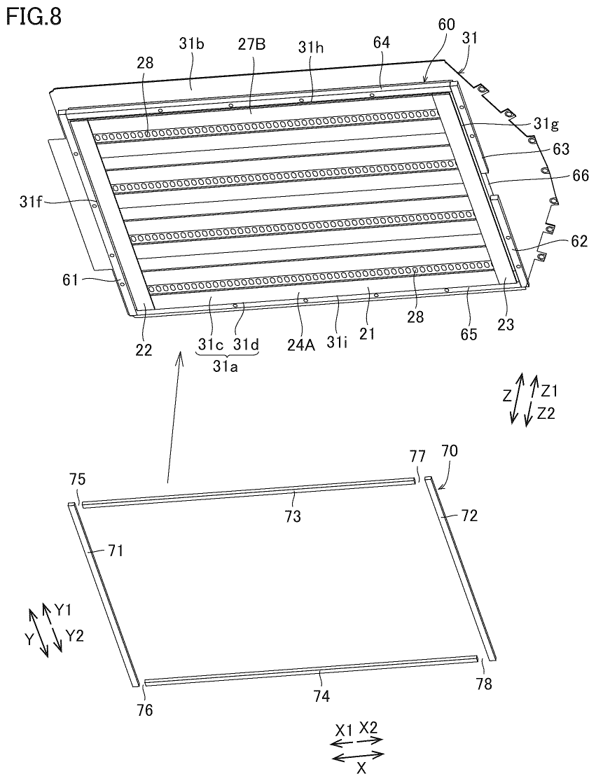

As shown in FIG. 8, power storage device 100 includes an inner path defining portion 70. Inner path defining portion 70 is disposed on the lower surface of cooler 20. Inner path defining portion 70 is an example of the “surrounding member” in the present disclosure.

Inner path defining portion 70 is disposed in smoke exhaust space S (FIG. 3) between share panel 33 and bottom plate 31c of lower case 31, and is formed in an annular shape.

Inner path defining portion 70 includes a front side portion 71, a rear side portion 72, a left side portion 73, and a right side portion 74. Front side portion 71 and rear side portion 72 are spaced apart from each other in the X direction. Each of front side portion 71 and rear side portion 72 extends in the Y direction. Left side portion 73 and right side portion 74 are spaced apart from each other in the Y direction. Each of left side portion 73 and right side portion 74 extends in the X direction.

An opened portion 75 is formed between front side portion 71 and left side portion 73. An opened portion 76 is formed between front side portion 71 and right side portion 74. An opened portion 77 is formed between rear side portion 72 and left side portion 73. An opened portion 78 is formed between rear side portion 72 and right side portion 74.

Front side portion 71 is located on the front side (X1 side) of inner path defining portion 70. Front side portion 71 is disposed on the lower surface of connection portion 22 of cooler 20.

Rear side portion 72 is located on the rear side (X2 side) of inner path defining portion 70. Rear side portion 72 is disposed on the lower surface of connection portion 23 of cooler 20.

Left side portion 73 is disposed between the left end (Y1-side end) of front side portion 71 and the left end (Y2-side end) of rear side portion 72. Left side portion 73 is disposed in flow portion 27B.

Right side portion 74 is disposed between the right end (Y2-side end) of front side portion 71 and the right end (Y2-side end) of rear side portion 72. Right side portion 74 is disposed in flow portion 24A.

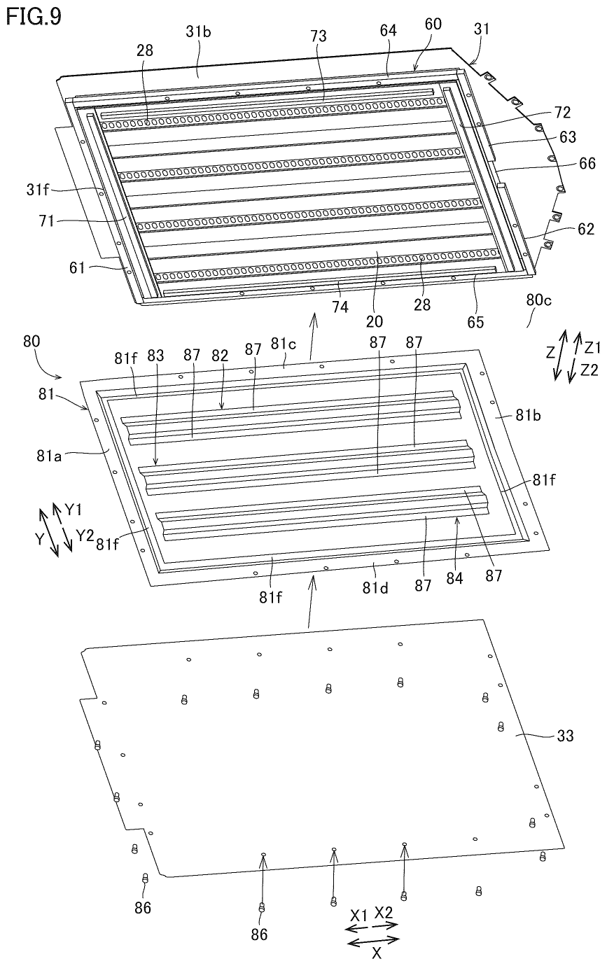

As shown in FIG. 9, power storage device 100 includes a support unit 80. Support unit 80 supports lower case 31 from below. Support unit 80 is disposed between lower case 31 and share panel 33.

Support unit 80 includes a frame portion 81 and support plates 82 to 84. Frame portion 81 includes support plates 81a to 81d. Frame portion 81 is formed of a single metal plate or the like. In other words, support plates 81a to 81d are integrally formed. Each of support plates 81a to 81d and support plates 82 to 84 is an example of the “lower case support plate” in the present disclosure.

Support plate 81a is provided to extend in the Y direction along front bracket 61 and front side portion 71. Support plate 81a is fixed to front bracket 61. Support plate 81b is provided to extend in the Y direction along each of rear bracket 62, rear bracket 63, and rear side portion 72. Support plate 81b is fixed to rear brackets 62 and 63.

Support plate 81c is provided to extend in the X direction along side bracket 64 and left side portion 73. Support plate 81c is fixed to side bracket 64. Support plate 81d is provided to extend in the X direction along side bracket 65 and right side portion 74. Support plate 81d is fixed to side bracket 65.

Support plates 82 to 84 are arranged in the Y direction while being spaced apart from each other in the space surrounded by frame portion 81 (support plates 81a to 81d). Each of support plates 82 to 84 is provided to extend in the X direction. Each of support plate 81c, support plate 81d, and support plates 82 to 84 extend in the direction (X direction) in which power storage cells 10 (smoke exhaust holes 31e (FIG. 7)) are arranged.

A Y1-side end of support plate 81a is connected to an X1-side end of support plate 81c. A Y2-side end of support plate 81a is connected to an X1-side end of support plate 81d. A Y1-side end of support plate 81b is connected to an X2-side end of support plate 81c. A Y2-side end of support plate 81b is connected to an X2-side end of support plate 81d.

Frame portion 81 (support plates 81a to 81d) is annularly fixed to bracket unit 60 formed annularly, together with share panel 33 with a plurality of bolts 86. In this manner, share panel 33 is annularly fixed to bracket unit 60.

Each of support plates 81a to 81d has a panel connection portion 81f, which will be described later. Also, each of support plates 82 to 84 has a panel connection portion 87, which will be described later. Each of panel connection portion 81f and panel connection portion 87 will be described later in detail.

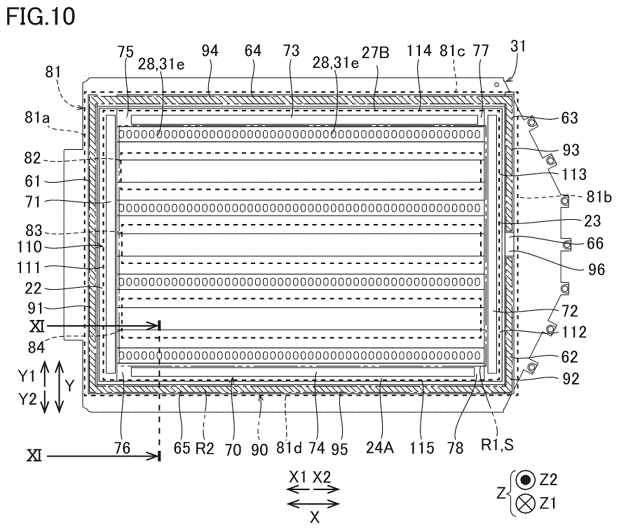

FIG. 10 is a bottom view showing cooler 20, bracket unit 60, and inner path defining portion 70. In FIG. 10, frame portion 81 and support plates 82 to 84 are indicated by the broken lines. In FIG. 10, a region RI indicates the region of bottom plate 31c of lower case 31 in which smoke exhaust holes 31e (holes 28) are formed. A contact region R2 indicates the region where support unit 80 (frame portion 81) and bracket unit 60 come into contact with each other. In FIG. 10, contact region R2 is hatched for easy viewing. Contact region R2 is located outside inner path defining portion 70. Contact region R2 is formed to surround inner path defining portion 70.

In contact region R2, an outer path defining portion 90 is formed as support unit 80 (frame portion 81) comes into contact with bracket unit 60. In other words, outer path defining portion 90 is located outside inner path defining portion 70 (71 to 74) and is formed to surround inner path defining portion 70. Outer path defining portion 90 is a seal portion formed by fastening of support unit 80 to bracket unit 60. This can prevent gas or the like from power storage cell 10 from leaking out of power storage device 100 through outer path defining portion 90.

Outer path defining portion 90 includes a front side portion 91, a rear side portion 92, a rear side portion 93, a lateral side portion 94, and a lateral side portion 95.

Front side portion 91 is located in front bracket 61. Rear side portion 92 and rear side portion 93 are located in rear bracket 62 and rear bracket 63, respectively. Similarly, lateral side portion 94 and lateral side portion 95 are located in side bracket 64 and side bracket 65, respectively.

An opened portion 96 is formed in outer path defining portion 90. Opened portion 96 is formed between rear side portion 92 and rear side portion 93. Opened portion 96 is provided at a position corresponding to gap 66 of bracket unit 60.

Inner path defining portion 70 and outer path defining portion 90 configured as described above form an exhaust passage 110 between support unit 80 (frame portion 81) and lower case 31.

Exhaust passage 110 includes a front passage 111, a rear passage 112, a rear passage 113, a side passage 114, and a side passage 115.

Front passage 111 is located between front side portion 71 and front side portion 91. Rear passage 112 is located between rear side portion 72 and rear side portion 92. Rear passage 113 is located between rear side portion 72 and rear side portion 93. Side passage 114 is located between left side portion 73 and lateral side portion 94. Side passage 115 is located between right side portion 74 and lateral side portion 95.

With share panel 33 attached to lower case 31, smoke exhaust space S surrounded by inner path defining portion 70 is formed between share panel 33 and lower case 31. As shown in FIG. 10, region R1 and smoke exhaust space S overlap each other as lower case 31 and the like are viewed from below in plan view.

Exhaust passage 110 is in communication with smoke exhaust space S through opened portions 75, 76, 77, 78. Exhaust passage 110 is in communication with the outside through opened portion 96.

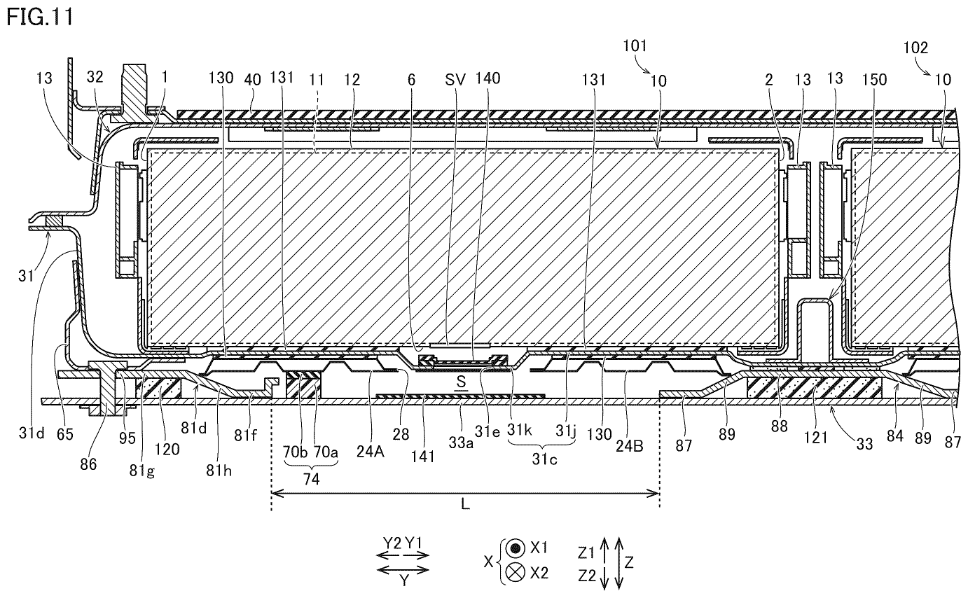

FIG. 11 is a sectional view taken along the line XI-XI in FIG. 10. In the cross section shown in FIG. 11, support plate 81d and support plate 84 of support unit 80 are shown. The configurations of support plates 81a to 81c are the same as that of support plate 81d, specific description of which will not be repeated. The configurations of support plates 82 and 83 are the same as that of support plate 84, specific description of which will not be repeated.

Herein, in a conventional power storage device, a smoke exhaust space for gas discharged from a safety valve provided on the lower surface of the power storage cell is formed below the power storage cell, and thus, when, for example, the power storage device interferes with a road surface and is subject to a load from below, the member that forms the smoke exhaust space may be damaged.

In the present embodiment, thus, support plate 81d and support plate 84 have a panel connection portion 81f and a panel connection portion 87 connected to share panel 33, respectively. Each of panel connection portion 81f and panel connection portion 87 is disposed below power storage cell 10. This can result in a relatively small length L of a beam portion 33a in the Y direction, which is a portion of share panel 33 corresponding to the portion between panel connection portion 81f and panel connection portion 87. As a result, the rigidity of share panel 33 can be increased. Beam portion 33a is provided below power storage cell 10.

Specifically, each of panel connection portion 81f and panel connection portion 87 is connected to share panel 33 by welding (spot welding). Consequently, no gap can be formed between panel connection portion 81f (panel connection portion 87) and share panel 33, thus preventing a blast, gas, and the like from power storage cell 10 from passing through below panel connection portion 81f (panel connection portion 87). Each of panel connection portion 81f and panel connection portion 87 may be connected to share panel 33 with an adhesive material or the like, or each of panel connection portion 81f and panel connection portion 87 may not be bonded to, but may be in contact with, share panel 33. Each of panel connection portion 81f and panel connection portion 87 is formed into a flat plane extending along share panel 33.

Referring again to FIG. 9, panel connection portion 81f is formed in a frame shape along the shape of frame portion 81. Specifically, panel connection portion 81f of each of support plate 81c and support plate 81d extends in the direction (X direction) in which power storage cells 10 are arranged. Panel connection portion 81f of each of support plates 81a and 81b extends in the Y direction. Panel connection portion 87 extends in the X direction. Panel connection portion 81f of each of support plate 81c and support plate 81d and panel connection portion 87 of each of support plates 82 to 84 are examples of the “cell-arrangement-direction extending portion” in the present disclosure.

Each of support plates 82 to 84 has a pair of panel connection portions 87. One of the pair of panel connection portions 87 is provided at a Y1-side end of each of support plates 82 to 84. The other of the pair of panel connection portions 87 is provided at a Y2-side end of each of support plates 82 to 84.

Panel connection portion 81f and panel connection portion 87 provided below the same power storage cell 10 will be described below. Panel connection portion 81f and panel connection portion 87 provided below the same power storage cell 10 are examples of the “first connection portion” and the “second connection portion”, respectively, in the present disclosure.

Panel connection portion 81f and panel connection portion 87 are provided below each of power storage stack 101 and power storage stack 104 (FIG. 2) as shown in FIG. 11, whereas two panel connection portions 87 are provided below each of power storage stack 102 and power storage stack 103 (FIG. 2).

Referring again to FIG. 11, panel connection portion 81f and panel connection portion 87 are spaced apart from each other in the Y direction. Smoke exhaust hole 31e of lower case 31 is provided between (at the center of) panel connection portion 81f and panel connection portion 87 in the Y direction.

Power storage cell 10 is formed to be elongated in the Y direction in which panel connection portion 81f and panel connection portion 87 are arranged. In other words, panel connection portion 81f and panel connection portion 87 are arranged in the long direction of power storage cell 10.

Panel connection portion 81f is positioned adjacent to right side portion 74 of inner path defining portion 70 in the Y direction. Panel connection portion 81f is provided on the Y2 side of right side portion 74. Panel connection portion 81f extends along inner path defining portion 70.

Support plate 81d has a panel separation portion 81g and a connection portion 81h, in addition to panel connection portion 81f. Panel separation portion 81g is spaced apart from share panel 33 above share panel 33. A lateral side portion 95 of outer path defining portion 90 is formed by contact (fastening) of panel separation portion 81g to side bracket 65. Panel separation portion 81g is formed of a flat plane extending parallel to share panel 33. Panel separation portion 81g is provided on the Y2 side (in the direction so as to be apart from smoke exhaust hole 31e) relative to panel connection portion 81f. Panel separation portion 81g is an example of the “portion being different from the panel connection portion” in the present disclosure. Connection portion 81h connects panel connection portion 81f to panel separation portion 81g. Specifically, connection portion 81h connects a Y2-side end of panel connection portion 81f to a Y1-side end of panel separation portion 81g. Connection portion 81h is inclined to share panel 33. Each of panel separation portion 81g and connection portion 81h extends along panel connection portion 81f.

Support plate 84 has a panel separation portion 88 and a pair of connection portions 89, in addition to the pair of panel connection portions 87. Panel separation portion 88 is spaced apart from share panel 33 above share panel 33. Panel separation portion 88 is formed of a flat plate extending parallel to share panel 33. Panel separation portion 88 is positioned to overlap the space between adjacent power storage stacks (power storage stack 101 and power storage stack 102 in FIG. 11) in the Z direction. Panel separation portion 88 is provided so as to be more distant from smoke exhaust hole 31e than panel connection portion 87 is from smoke exhaust hole 31e. Panel separation portion 88 is an example of the “portion being different from the panel connection portion” in the present disclosure.

Each of the pair of connection portions 89 connects panel connection portion 87 to panel separation portion 88. Specifically, one on the Y2 side of the pair of connection portions 89 connects one on the Y2 side of the pair of panel connection portions 87 to panel separation portion 88. One on the Y1 side of the pair of connection portions 89 connects one on the Y1 side of the pair of panel connection portions 87 to panel separation portion 88. Each of the pair of connection portions 89 is inclined to share panel 33. Panel separation portion 88 and each of the pair of connection portions 89 extend in the X direction along panel connection portion 87.

Power storage device 100 includes a spacer 120 and a spacer 121. Spacer 120 is disposed in a gap formed between panel separation portion 81g and share panel 33. Spacer 120 supports support plate 81d (frame portion 81) from below. Spacer 120 is provided on the Y2 side relative to panel connection portion 81f (on the side opposite to smoke exhaust hole 31e). Spacer 120 has a shape (frame shape) (FIG. 12) extending along frame portion 81. Spacer 120 may be formed in a frame shape by combination of a plurality of members extending linearly. Each of spacer 120 and spacer 121 is an example of the “support member” in the present disclosure.

Spacer 121 is disposed in the gap formed between panel separation portion 88 and share panel 33. Spacer 121 supports support plate 84 (and support plates 82, 83) from below. Spacer 121 is provided below each of support plates 82 to 84. Spacer 121 extends in the X direction along each of support plates 82 to 84 (FIG. 12). Spacer 121 is provided opposite to smoke exhaust hole 31e relative to panel connection portion 87.

Spacer 120 is bonded to each of panel separation portion 81g and share panel 33 with an unshown adhesive material (e.g., adhesion tape) provided on each of the upper surface and the lower surface of spacer 120. Spacer 121 is bonded to each of panel separation portion 88 and share panel 33 with an unshown adhesive material (e.g., adhesion tape) provided on each of the upper surface and the lower surface of spacer 121.

Each of spacer 120 and spacer 121 is made of, for example, foamed resin.

As each of spacer 120 and spacer 121 is provided, the gap between share panel 33 and support unit 80 (panel separation portions 81g, 88) is filled. In addition, share panel 33 is connected to support unit 80 (panel separation portions 81g, 88). This can increase the integrity of share panel 33 and support unit 80, thus increasing the overall rigidity (integral rigidity) of support unit 80 and share panel 33.

Referring again to FIG. 11, inner path defining portion 70 (what is shown in FIG. 11 is right side portion 74) has a body part 70a and a bonding part 70b. Body part 70a is made of, for example, a silicon resin. Body part 70a is disposed on share panel 33.

Bonding part 70b is disposed on the upper surface of body part 70a. Bonding part 70b is in contact with cooler 20 (flow portion 24A in FIG. 11). Bonding part 70b may be an adhesion tape having adhesion layers provided on opposite surfaces thereof, and is bonded to each of cooler 20 and body part 70a. This allows inner path defining portion 70 to be stably fixed to share panel 33 and can suppress passing through of a blast, gas, and the like from power storage cell 10 above and below inner path defining portion 70. The part of inner path defining portion 70 other than right side portion 74 has the same configuration as that of right side portion 74.

Bottom plate 31c of lower case 31 includes a bottom body 31j on which power storage cell 10 is disposed, and a protrusion 31k. A plurality of protrusions 31k are spaced apart from each other in the Y direction. Each protrusion 31k is formed to extend in the X direction. Protrusion 31k is formed to protrude downward from bottom body 31j. The lower end of protrusion 31k is located in a hole 28 formed in cooler 20. Smoke exhaust hole 31e is formed in the lower end of protrusion 31k.

A thermally conductive adhesive material 130 is provided between bottom body 31j and cooler 20. Thermally conductive adhesive material 130 bonds bottom body 31j to cooler 20. In addition, a thermally conductive adhesive material 131 is provided between bottom body 31j and lower surface 6 of power storage cell 10. Thermally conductive adhesive material 131 bonds bottom body 31j to power storage cell 10. Each of thermally conductive adhesive materials 130 and 131 extends along the X direction.

Power storage device 100 includes a heat insulating plate 140 and a heat insulating plate 141. Heat insulating plate 140 is disposed between hole 28 of cooler 20 and safety valve SV of power storage cell 10. Specifically, heat insulating plate 140 is provided in the space between protrusion 31k and lower surface 6 of power storage cell 10 and is disposed at the lower end of protrusion 31k. Heat insulating plate 140 is made of, for example, mica obtained by solidifying a natural inorganic mineral through heat pressing. Heat insulating plate 140 is disposed to cover smoke exhaust holes 31e arranged in the X direction from above.

Heat insulating plate 141 is provided at a part of share panel 33 which faces safety valve SV. Heat insulating plate 141 is made of, for example, mica. Heat insulating plate 141 is formed to extend in the X direction. Heat insulating plate 141 is located below smoke exhaust holes 31e arranged in the X direction.

Power storage device 100 includes a cross member 150. Cross member 150 is connected to a part of bottom plate 31c of lower case 31 which is located between a pair of adjacent power storage stacks. Cross member 150 is supported from below by panel separation portion 88 of support plate 84 (and support plates 82, 83). Cross member 150 extends in the X direction. Cross member 150 is connected to peripheral wall 31d. Cross member 150 may be connected to the pair of first frames 921 (FIG. 2) with a bracket (not shown) in between.

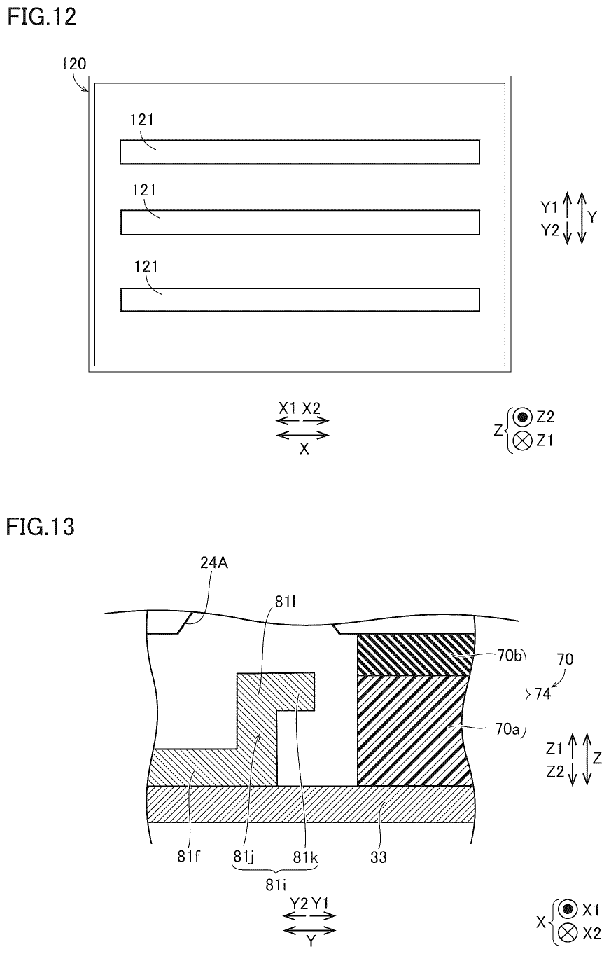

FIG. 13 is a partially enlarged view of panel connection portion 81f and its vicinity. Support plate 81d (and support plates 81a to 81c) includes a blast collection portion 81i. Blast collection portion 81i collects a blast released from smoke exhaust hole 31e. Blast collection portion 81i is provided outside inner path defining portion 70. At the position shown in FIG. 13, blast collection portion 81i is provided on the Y2 side of right side portion 74 (on the side opposite to smoke exhaust hole 31e).

Blast collection portion 81i is connected to a Y1-side end of panel connection portion 81f. Blast collection portion 81i has a standing portion 81j and an eaves portion 81k. Standing portion 81j extends to the Z1 side from the Y1-side end of panel connection portion 81f. Eaves portion 81k projects to the inner path defining portion 70 side (Y1 side) from upper end 81l of standing portion 81j. Blast collection portion 81i has an L shape. The shape of blast collection portion 81i is not limited to the above example. Standing portion 81j and eaves portion 81k are examples of the “first part” and the “second part”, respectively, in the present disclosure. Also, upper end 81l is an example of the “upper portion” in the present disclosure.

Eaves portion 81k is separated from inner path defining portion 70 (right side portion 74) in FIG. 13, but eaves portion 81k may be in contact with inner path defining portion 70 (right side portion 74). Also, the upper end (eaves portion 81k) of blast collection portion 81i is located below cooler 20 in FIG. 13, but blast collection portion 81i may be flush with the lower end of cooler 20.

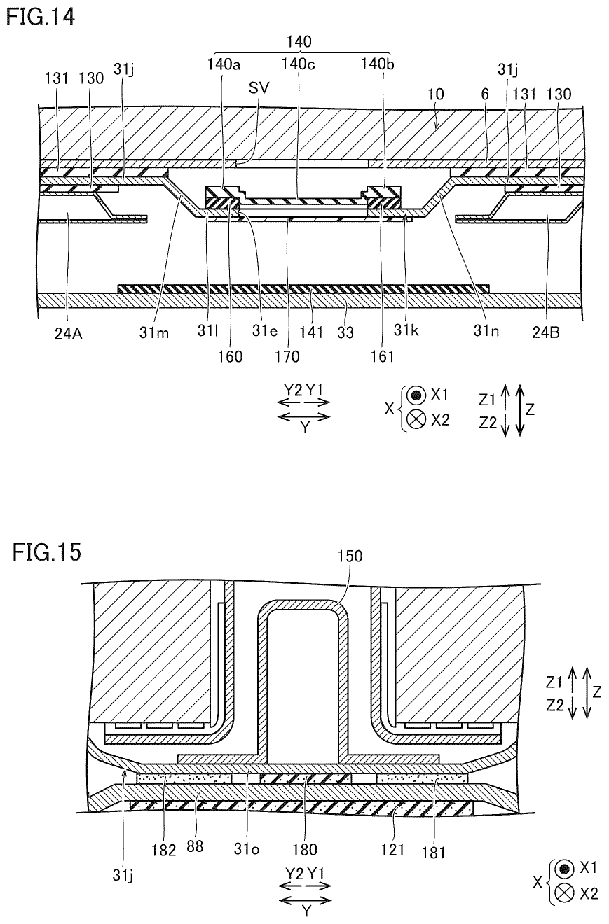

FIG. 14 is a partially enlarged view showing a configuration of protrusion 31k and its vicinity. Protrusion 31k includes a bottom plate 311 and side walls 31m, 31n. Each of side wall 31m and side wall 31n is formed to connect bottom plate 311 to bottom body 31j. Bottom plate 311 has smoke exhaust hole 31e.

Power storage device 100 includes waterproof adhesives 160, 161 and a waterproof sheet 170. Each of waterproof adhesive 160 and waterproof adhesive 161 is disposed on the upper surface of bottom plate 311 and is formed to extend in the X direction. Waterproof adhesive 160 and waterproof adhesive 161 are spaced apart from each other in the Y direction. In plan view, smoke exhaust hole 31e is disposed between waterproof adhesive 160 and waterproof adhesive 161.

Heat insulating plate 140 has a support portion 140a, a support portion 140b, and a closing plate 140c. Support portion 140a is disposed on the upper surface of waterproof adhesive 160. Support portion 140b is disposed on the upper surface of waterproof adhesive 161. Closing plate 140c is disposed from support portion 140a to support portion 140b.

Waterproof adhesives 160, 161 and heat insulating plate 140 close smoke exhaust hole 31e on the upper surface side of protrusion 31k. Waterproof adhesives 160, 161 and heat insulating plate 140 are formed to extend in the X direction and close smoke exhaust holes 31e arranged in the X direction.

Waterproof sheet 170 is disposed on the lower surface of protrusion 31k and closes smoke exhaust hole 31e. Waterproof sheet 170 is formed to extend in the X direction and closes smoke exhaust holes 31e arranged in the X direction.

FIG. 15 is a partially enlarged view showing a configuration of cross member 150 and its vicinity. Bottom body 31j includes a support portion 310 that supports cross member 150 from below. Support portion 31o is provided to extend in the X direction along cross member 150. Also, as shown in FIG. 15, support portion 310 is formed to extend along the Y direction.

Support portion 31o is provided above panel separation portion 88. A spacer 180, an adhesive material 181, and an adhesive material 182 are provided between support portion 31o and panel separation portion 88. Spacer 180, adhesive material 181, and adhesive material 182 are provided side by side in the Y direction. Spacer 180 is provided between adhesive material 181 and adhesive material 182. Spacer 180 is in contact with the central portion of support portion 31o in the Y direction. Adhesive material 181 and adhesive material 182 are in contact with a Y1-side end and a Y2-side end of support portion 31o, respectively. Each of spacer 180, adhesive material 181, and adhesive material 182 is provided to extend in the X direction. Spacer 180 is made of, for example, foamed resin.

In power storage device 100 described above, support unit 80 has the panel connection portion (81f, 87) connected to share panel 33, and the panel connection portion (81f, 87) is disposed below power storage cell 10. Thus, the portion (beam portion 33a) of share panel 33 below power storage cell 10 is stably held by panel connection portion 81f and panel connection portion 87. This can increase the rigidity of share panel 33, thus suppressing damage to share panel 33 by a load applied from below. Also, since the panel connection portion (81f, 87) is provided below power storage cell 10, transmission of the load applied from below to power storage cell 10 can be suppressed.

### Modifications

The above embodiment has illustrated the example in which support unit 80 includes frame portion 81 and the support plate (82 to 84), but the present disclosure is not limited thereto. Any one of frame portion 81 and the support plate (82 to 84) may be provided.

The above embodiment has illustrated the example in which blast collection portion 81i is provided in only frame portion 81, but the present disclosure is not limited thereto. Blast collection portion 81i may also be provided in support plate (82 to 84).

The above embodiment has illustrated the example in which the spacer (120, 121) is provided in the gap formed between support unit 80 and share panel 33, but the present disclosure is not limited thereto. For example, no gap may be formed between support unit 80 and share panel 33.

The above embodiment has illustrated the example in which panel connection portion 81f and panel connection portion 87 are arranged in the long direction of power storage cell 10, but the present disclosure is not limited thereto. Panel connection portion 81f and panel connection portion 87 may be arranged in the short direction of power storage cell 10.

The above embodiment has illustrated the example in which eaves portion 81k of blast collection portion 81i is connected to upper end 81l of standing portion 81j, but the present disclosure is not limited thereto. Eaves portion 81k may be connected to the part of the upper portion of standing portion 81j which is located below upper end 81l.

Although the present embodiments of the present disclosure have been described, it should be understood that the present embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
at least one power storage cell; and
a housing, wherein
the at least one power storage cell includes a lower surface on which a safety valve is provided,
the housing includes
a lower case supporting the at least one power storage cell from below,
a share panel provided below the lower case and forming a space between a bottom surface of the lower case and the share panel, and
a lower case support plate disposed between the lower case and the share panel and supporting the lower case,
the bottom surface of the lower case has a through hole, the through hole being positioned to overlap the safety valve of the at least one power storage cell,
the lower case support plate includes a panel connection portion connected to the share panel, and
the panel connection portion is disposed below the at least one power storage cell.

2. The power storage device according to claim 1, further comprising a surrounding member disposed in the space between the share panel and the bottom surface of the lower case and surrounding a region of the bottom surface of the lower case, the through hole being formed in the region,
wherein the lower case support plate includes a blast collection portion located outside the surrounding member.

3. The power storage device according to claim 2, wherein the blast collection portion includes
a first part extending upward from the panel connection portion, and
a second part projecting from an upper portion of the first part toward the surrounding member.

4. The power storage device according to claim 1, further comprising a support member disposed in a gap formed between the share panel and a portion of the lower case support plate, the portion being different from the panel connection portion, the support member supporting the lower case support plate from below.

5. The power storage device according to claim 4, wherein the support member is provided opposite to the through hole relative to the panel connection portion.

6. The power storage device according to claim 1, wherein the panel connection portion includes a first connection portion and a second connection portion.

7. The power storage device according to claim 6, wherein the at least one power storage cell is formed to be elongated in a connection portion arrangement direction in which the first connection portion and the second connection portion are arranged.

8. The power storage device according to claim 1, wherein
the at least one power storage cell includes a plurality of power storage cells arranged in a cell arrangement direction such that a plurality of the safety valves are arranged in the cell arrangement direction, and
the panel connection portion includes a cell-arrangement-direction extending portion extending in the cell arrangement direction along the plurality of power storage cells.
